(19) United States
(12) Patent Application Publication
(10) Pub. No.: US 2018/0194302 A1
(43) Pub. Date: Jul. 12, 2018

(54) Magnetically Attached Foam Guards

(71) Applicant: Mark Lee Yates, Peoria, AZ (US)

(72) Inventor: Mark Lee Yates, Peoria, AZ (US)

(21) Appl. No.: 15/401,108

(22) Filed: Jan. 9, 2017

(51) Int. Cl. B60R 13/04

(52) U.S. Cl. CPC B60R 13/04

(57) ABSTRACT

Magnetically Attached Foam Guards to help reduce Door Dings, dents, scratches, scrapes on items made in whole or in part of iron, nickel, cobalt, or steel. Fabric Material “86” is used to encase foam and/or padding “50” and a row of magnets “70”, or as an alternative, a magnetic strip “71” to magnetically adhere an embodiment onto items made in whole, or in part of iron, nickel, cobalt or steel. Embodiments can be manufactured with the foam and/or padding “50” encased in fabric “69” (FIG. 3A), or foam and/or padding “50” exposed and attached to the fabric framework “89” (FIG. 5C). Although an embodiment can be used to cover a portion, or entire side of an Automobile to protect a vehicle from Door Dings, dents, scratches, or scrapes, embodiments can be used on many other items to reduce damage.

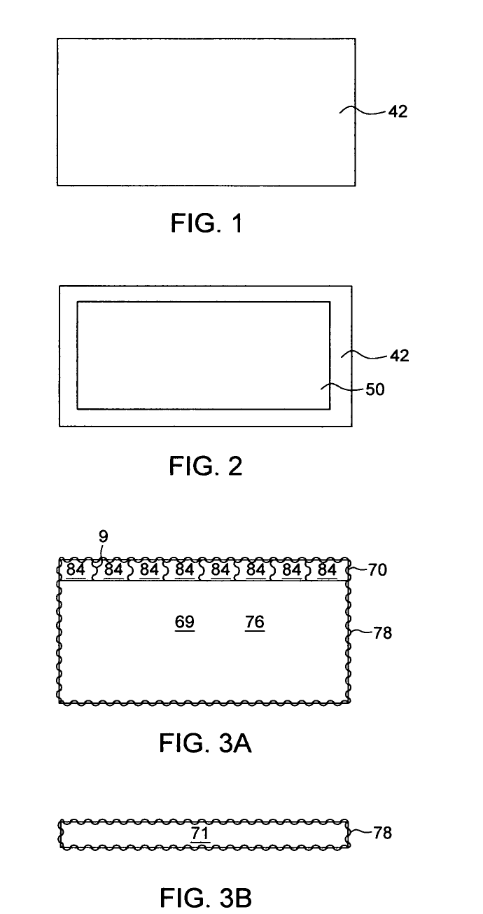

“Magnetically Attached Foam Guards” can help reduce dents, scratches and other damage on anything that is made in whole, or in part of: iron, nickel, cobalt or steel. As an example, Embodiment “A” can be used to help reduce automobile: door dings (light dents), scratches, and other damage that can occur on Automobiles' doors and/or complete side panels. Embodiment “A” comprising of: any fabric material (FIG. 1) “42” to serve as the backing, and any configuration of foam or padding (FIG. 2) “50”, which is sealed inside a top piece of fabric material (FIG. 3A) “69”. Bottom backing material “42” and top material “69” encases “50” in FIG. 3A by sewing the perimeters with any Thread or Loop and hook material “78”. Material enclosing magnets “70” can be made of any fabric material to encase a row of magnets of any size or strength (FIG. 3A) “84”, held in place by individually sewn compartments (FIG. 3A) “9”, or alternatively an encased magnetic strip (FIG. 3B) “71”. Magnet encasement “70” is one example of how individual magnets “84”, (FIG. 3A) or alternatively, a magnetic strip (FIG. 3B) “71” can be manufactured to adhere embodiments to the doors, and or side panels (in part or entire side) of automobiles which are made with any type of material in which magnets or magnetic strips will adhere to.

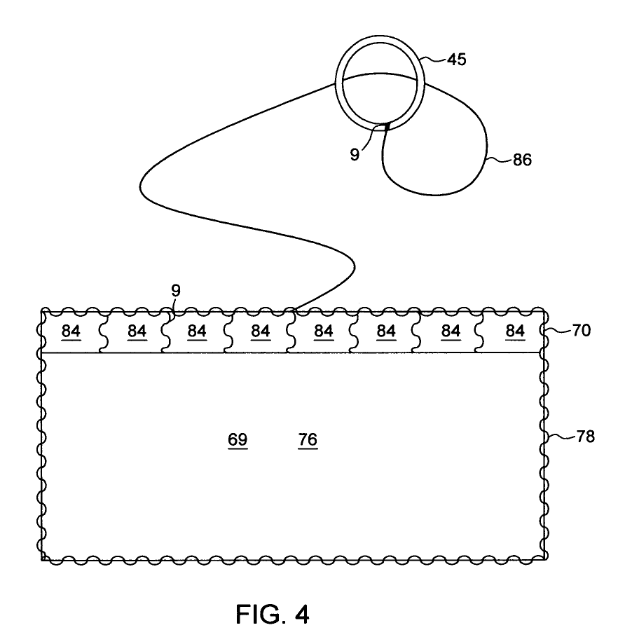

As an alternative to Embodiment “A”, FIG. 4 represents a top view of optional Embodiment “B”. Embodiment “B” has a piece of fabric cord “86” which has been sewn “9” to a ring made of any material “45”, which threading “86” through ring“45” creates a noose to loop around the inside of any part of an automobile (example: around a headrest) to serve as an anti-theft device. Customization can occur anywhere on any Embodiment “76”, which can be manufactured with optional/lawful customization per the Customer's request. Examples of customization might be, but not limited to: names, numerals, alphabetic letters, any lawful images, company logos, heat transfers either purchased or provided by the Customer. Although the above description represents Embodiment “B”, there are many alternative embodiments of “Magnetically Attached Foam Guards” which can be manufactured.

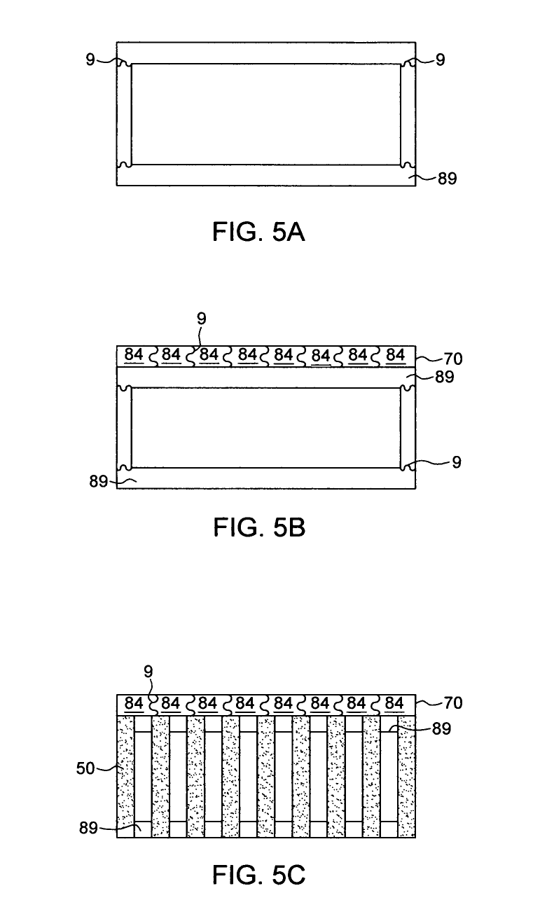

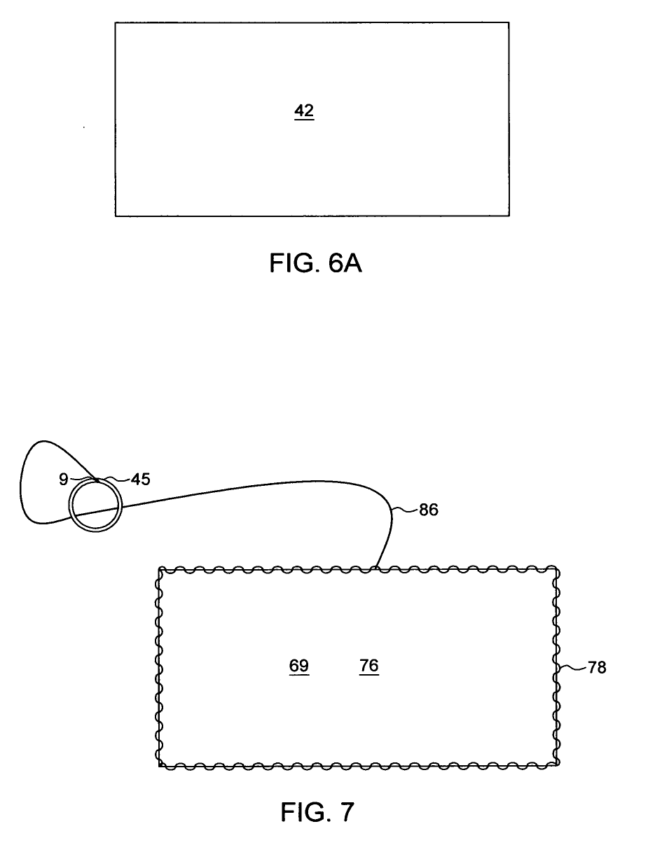

Alternative Embodiment “C” FIG. 5A utilizes a fabric material (of any type) “89”, which is sewn or adhered together “9”, so that magnetic encasement “70” in FIG. 5B can be sewn “9” to the top of Embodiment “C”. FIG. 5C illustrates the individual pieces of foam/and or padding of any density or thickness, “50”, to be sewn or adhered “89” from the bottom, top and middle of Embodiment “C”. Foam and/or padding “50” can be of any density or weight, and can be individual pieces side by side, or staggered every few inches. Alternative Embodiment “E”, (FIG. 7) is Embodiment “C” with an optional attached fabric cord material “86”, which has a metal ring “45” sewn “9” on the end, to serve as an anti-theft device by the fabric cord “86” being threaded thru the ring “45”, creating a noose, as illustrated in FIG. 7, then Looping fabric cord “86” around any part of the inside of the automobile (example, but not limited to a headrest). Embodiment “E” also has a fabric backing, “42”, (FIG. 6A) in which Embodiment “C” is laid upon, then stitched together “78” on the perimeter. A top piece of fabric material “69” (FIG. 7) is placed on top for encasement by sewing “78” bottom material “42” on the outside perimeter to top side fabric “69”. I contemplate Embodiments “A”-“E” are a few examples of how “Magnetically Attached Foam Guards” can be manufactured, however, many alternative manufacturing modifications in the future are possible.

### DRAWINGS

### Figures (Embodiment “A”-Embodiment “B”)

FIG. 1 shows Embodiment “A” fabric backside “42”.

FIG. 2 shows Embodiment “A” foam/and or padding “50” that lays on “42”

FIG. 3A shows Embodiment “A” fabric topside covering FIG. 2.B foam/& or padding.

FIG. 3A shows Embodiment ‘A” stitching “78” to sew perimeters.

FIG. 3A shows in Embodiment ‘A” a strip of fabric “70” encasing individual magnets “84”, which are held in place by sewn compartments “9”.

FIG. 3B shows in Embodiment ‘A” that an encased magnetic strip “71” could be substituted for the row of individual magnets “70” in FIG. 3A.

FIG. 4 shows a cord or strip of fabric “86” which can be any length, sewn “9” to Embodiment “B”.

FIG. 4. shows on Embodiment “B”, a metal ring “45” which is sewn “9” to the end of a fabric cord “86” to serve as an anti-theft device.

FIG. 4. shows on Embodiment “B”, a loop in the fabric cord “86”, which can be threaded through the ring “45”, creating a noose.

### Figures Embodiments “C”-“E”

FIG. 5A shows Embodiment “C” with 4 strips of fabric “89”, sewn “9” together in rectangular form, however FIG. 5A can be of any shape or size. FIG. 5B of Embodiment “C” shows a piece of fabric “70” encasing individual magnets “84”, which are held in place by individual sewn stitches “9” to create compartments for the magnets “84”. The encasement of individual magnets “70” however, can be omitted being substituted for a magnetic strip (FIG. 3B) “71”, running the length of FIG. 5C as an alternative Embodiment. FIG. 5C shows Embodiment “C” with foam/and or padding “50” being layed on top of FIG. 5A. Fabric “89” running under and over “50”, with individual stitching “9” on each side of foam pieces“50” to hold each foam piece “50” in place. Fabric strips “89” are manufactured at the top, and bottom of Embodiment “C” to hold all foam pieces“50” in place.

FIG. 6A is the bottom fabric “42” of Embodiment “E”.

FIG. 7 shows Embodiment “E” with a sewn on piece of fabric “86” which has a metal ring “45” that has been sewn “9” on to the end of fabric cord “86”. The fabric cord “86” is then threaded through ring “45” creating a noose, which can then be looped around any interior portion of an automobile to serve as an anti-theft device. Bottom fabric “42” and top fabric “69” sewn “9” at perimeters.

### REFERENCE LETTERS

9 Sewn Stitches
42 Bottom piece of fabric.
45 Metal ring
50 Foam and/or Padding
69 Top piece of Fabric
70 Strip of fabric material encasing magnets
71 Optional magnetic strip encased in fabric.
76 Optional Customization includes but not limited to heat transfers or adhesive stickers.
78 outside perimeter stitching
84 Magnets
86 Fabric cord or fabric strap of any length.
89 Strips of fabric, or alternatively, hook and loop material

### Detailed Description FIGS. 1, 2, 3A, 3B Embodiment “A”

One embodiment of the Magnetically Attached Foam Guards is illustrated in FIG. 1 as bottom backing “42” of the enclosure. FIG. 2 illustrates the foam, and/or Padding “50”, placed on top of bottom backing“42”. FIG. 3A illustrates a strip of fabric “70”, which is sewn across the top, from the left to the right. A fabric enclosure “70” containing magnets “84”, which retain their spacing inside magnetic enclosure “70” by sewing several Stitches “9”, to the left and right of each magnet “84” “encased. A top fabric layer “69” is then placed over FIG. 2, and sewn together “78” on the outer perimeter of the fabric. FIG. 3B is an alternative, encased magnetic strip “71” which could be substituted for magnetic encasement “70”. FIG. 3A Customer/Client identification “76”, can encompass any part, or in whole, the front side of the outer fabric material “69”.

### Operation—FIG. 3A Embodiment “A”

Hold Embodiment “A”, “FIG. 3A” by hand, and starting at any point at the rear of an automobile, begin attaching said Embodiment to the end of the car, a few inches below the glass windows. The magnets “84” inside the top encasement, “70” will adhere to any automobile that has either side and/or door panels made in part or in whole of steel. As said Embodiment reaches the middle of the automobile, continue adhering the Magnets “84” until said Embodiment is fully adhered to the side of the car. Although said Embodiment can be adhered to an automobile, said Embodiment can be adhered to any structure or items made in whole, or in part of: Iron, Nickel, Cobalt, or Steel to help in reducing dents, scratches, and other minor cosmetic damage.

### Detailed Description FIG. 4 Alternative Embodiment “B”

FIG. 4 illustrates a finished product of Embodiment “A” (FIG. 3A), that includes an optional fabric cord “86”, sewn “9” to Embodiment “A”, creating said Embodiment “B”. At one end of the fabric cord “86”, a metal ring “45”, sewn “9” to one end of Fabric cord “86”, which loops through the metal ring “45”, creating a noose. FIG. 4 illustrates an area for personal Customization “76” which can be placed anywhere on the front of the fabric material “69”.

### OPERATION—FIG. 4 EMBODIMENT “B”

The manner of using the Magnetically Attached Foam Guards is to hold Embodiment “B”, “FIG. 4” by hand, and starting at any point at the rear of an automobile, begin attaching said Embodiment to the end of the car, a few inches below the glass windows. The magnets “84” inside the top encasement, “70” will adhere to any automobile that has either side and/or door panels made in part or in whole—steel. As Embodiment “B” adheres to the back side of the vehicle, the front vehicle door can then be opened, and the fabric cord “86”, can be threaded through the metal ring “45”, which will then create a noose to go around any secure portion of the car interior. As an example, Embodiment “B” can use the headrest of an automobile to loop over, and tighten the noose, however any secure interior part of the vehicle (example: front seat) can be used to place the fabric cord “86” over, and then tighten to serve as an anti-theft device. With the fabric cord “86” secured to an interior part of the Automobile (cab area which can be locked), the automobile front door can then be closed, and the remaining portion of Embodiment “B” can be magnetized to the outside front door section, and beyond to the front side in part, or in whole of the vehicle.

### Detailed Description FIGS. 5A, 5B, 5C Embodiment “C”

FIG. 5A is an additional embodiment, that could be of any height, width, length or shape. This possible alternative—Embodiment “C”, could have four pieces of fabric; “89”. Connecting Fabric “89” by sewing stitches “9” in four corners, would be considered the framework. FIG. 5B shows the Magnet encasement “70” would be sewn “9” at the top of said Embodiment. FIG. 5C illustrates Foam padding “50” is placed below “70”, and over the fabric framework, laying on top of FIG. 5A. Two additional pieces of fabric “89” are then placed under and over the foam and/or padding at the top and bottom of said Embodiment, and is then sewn “9” to the left side and right side of each foam piece “50”, thereby holding each foam and or padding in place. Fabric “89” is also sewn “9” at the bottom of said Embodiment just as described at the top.

### Operations for FIG. 5C Embodiment “C”

Hold Embodiment “C”, “FIG. 5C” by hand, and starting at any point at the rear of an automobile, begin attaching said Embodiment to the end of the car, a few inches below the glass windows. The magnets “84” inside the top encasement “70” will adhere to any automobile that has either side and/or door panels made in part or in whole of steel. As said Embodiment reaches the middle of the automobile, continue adhering the Magnets “84” until said Embodiment is fully adhered to the side of the car. Although said Embodiment can be adhered to an automobile, said Embodiment can be adhered to any structure or items made in whole, or in part of: Iron, Nickel, Cobalt, or Steel to help in reducing dents, scratches, and other minor cosmetic damage.

### Detailed Description FIG. 6A—FIG. 7 Embodiment “E”

FIG. 6A illustrates a bottom piece of fabric “42”. Embodiment “C” (FIG. 5C) is then laid on top of bottom Fabric “42”. FIG. 7 illustrates top fabric “69” being placed on top, and sewn “78” to bottom fabric “42” around the perimeter of said Embodiment. One end of a fabric cord “86” is sewn “9” to the top of said Embodiment. On the other end of the fabric cord “86”, a metal ring “45”, is sewn “9”. The fabric cord “86” loops through the metal ring “45”, creating a noose. FIG. 7 illustrates an area for personal Customization “76” which can be placed anywhere on the front of the fabric material “69”.

### Operations FIG. 6A—FIG. 7 Embodiment “E”

The manner of using the Magnetically Attached Foam Guards is to hold Embodiment “E”, “FIG. 7” by hand, and starting at any point at the rear of an automobile, begin attaching said Embodiment to the end of the car, a few inches below the glass windows. The magnets “84” inside the top encasement “70” will adhere to any automobile that has either side and/or door panels made in part or in whole—steel. As said Embodiment adheres to the back side of the vehicle, the front vehicle door can then be opened, and the fabric cord “86”, can be threaded through the metal ring “45”, which will then create a noose to go around any secure portion of the car interior. As an example, said Embodiment can use the headrest of an automobile to loop over, and tighten the noose, however any secure interior part of the vehicle (example: front seat) can be used to place the fabric cord over, and then tighten to serve as an anti-theft device. With the fabric cord “86” secured to an interior part of the Automobile (cab area which can be locked), the automobile front door can then be closed, and the remaining portion of said Embodiment can be magnetized to the outside front door section, and beyond to the front side in part, or in whole of the vehicle.

### CONCLUSION, RAMIFICATIONS, AND SCOPE

Accordingly, the reader will conclude that by utilizing one of the various Embodiments Described herein, will greatly reduce the number of Automobile damage occurrences caused by including (but not limited to): Door Dings (small dents), scratches, abrasions, scrapes, which can occur to an automobile virtually anywhere it is parked. Automobiles can receive damage by being parked inside a homeowner's garage: (a) a second vehicle parked inside, and a car door swings open hitting the other parked Automobile, (b) a Bicycle handle without a protective rubber cover on the hand grip can make contact with a parked Automobile in the garage, creating a long scratch when the metal handlebar makes contact with the Automobile. Automobiles in tight shopping Mall and Grocery store parking spaces are constantly exposed to doors being opened by other vehicles right next to them, or unattended shopping carts striking a parked Automobile. Apartment complex tight parking spaces, Airport parking spaces, virtually any parking space subjects an Automobile to potential damage including, but not limited to Door Dings, light dents, scratches, and scrapes. Magnetically Attached Foam Guards will greatly reduce the damage described above by simply adhering said embodiments to the sides of Automobiles, whenever and wherever Automobiles are parked. Magnetically Attached Foam Guards will provide increased protection for the autos.

Although the description above contains many specificities, these should not be construed as limiting the scope of the embodiments to just automobile protection, but merely providing a few illustrations of some alternative embodiments. For example, all of the embodiments illustrated have no limitation as to: size, shape, color, or what iron, nickel, cobalt or steel structure the embodiment is protecting. The embodiments illustrated are not limited to just protecting the sides of Automobiles. The embodiments can be used and marketed to protect anything in whole or in part made of: iron, nickel, cobalt, or steel, that needs protection from: light dents, scratches, abrasions, and scrapes.

Thus, the scope of the embodiments should be determined by the claims and their legal equivalents, rather than by the limited amounts of examples given.

What is claimed is:

1. I claim, a row of magnets, or any configuration of magnets, or a magnetic strip encased in any type of fabric material, extending any length, height or width from the left side of embodiments to the right side of embodiments.

2. I claim, any foam and/or padding configuration encased or exposed, and extending any length, width or height from left side to right side of said embodiments.

3. I claim, encased magnetic configuration and encased or exposed foam and/or padding configuration to be adhered or attached together by a framework made of any type of fabric material so that embodiments can be magnetically attached to anything made in whole or in part of: iron, nickel, cobalt, or steel.

4. I claim, optional embodiments can be manufactured with an anti-theft feature.
